(19) United States
(12) Patent Application Publication
(10) Pub. No.: US 2026/0210231 A1
(43) Pub. Date: Jul. 23, 2026

(54) Test Device and Test Method for While-Drilling Casing Collapse and Cementing Quality Evaluation

(71) Applicant: China Oilfield Services Ltd., Binhai New Area Tianjin (CN)

(72) Inventors: Zhifeng SUN, Tianjin (CN); Huatao LU, Tianjin (CN); Ya JIN, Tianjin (CN); Xien LIU, Tianjin (CN); Jie LI, Tianjin (CN)

(73) Assignee: China Oilfield Services Ltd., Binhai New Area Tianjin (CN)

(21) Appl. No.: 19/157,732

(22) PCT Filed: Jul. 12, 2023
(86) PCT No.: PCT/CN2023/106895

§ 371 Date: Aug. 19, 2025

(30) Foreign Application Priority Data
Feb. 24, 2023 (CN) 202310181806.4

(51) Int. Cl. E21B 47/005; G01N 29/07; G01N 29/265

(52) U.S. Cl. CPC E21B 47/005; G01N 29/07; G01N 29/265; G01N 2291/2636

(57) ABSTRACT

This disclosure discloses a testing apparatus and method for casing damage while drilling and cementing quality evaluation, which addresses technical challenges such as low well-logging efficiency, poor testing accuracy, and the difficulty in evaluating the cementing quality at the outer interface of the cement sheath. The apparatus comprises a drill collar sub, an ultrasonic probe, and a plurality of ultrasonic transducers; the excitation frequency of the ultrasonic probe is adjustable through an external control module; the plurality of ultrasonic transducers has respective center frequencies that are different from others, and the center frequencies progressively increase.

### CROSS REFERENCE TO RELATED APPLICATIONS

This application claims priority to Chinese Patent Application No. 2023101818064, titled “Testing Apparatus And Testing Method For Casing Damage While Drilling and Cementing Quality Evaluation”, filed on Feb. 24, 2023 with the China National Intellectual Property Administration, the entire contents of which are incorporated herein by reference.

### TECHNICAL FIELD

The present disclosure relates to the field of logging tool, and more specifically, relates to a testing apparatus and method for casing damage while drilling and cementing quality evaluation.

### BACKGROUND

In offshore oil and gas resource development operations, casing damage detection and cementing quality evaluation play a crucial role in maintaining and increasing production. Currently, ultrasonic pulse-echo methods are commonly used to detect casing wall thickness information. Additionally, by utilizing the attenuation of casing resonance waves, it is possible to obtain a cement sonic impedance imaging curve of an inner interface (the interface between the cement sheath and the casing) of a cement sheath, thereby performing cementing quality evaluation.

Currently, wireline ultrasonic well-logging apparatus are widely used. The well-logging apparatus equipped with an ultrasonic probe is lowered into the wellbore via a cable, and then the well-logging apparatus is driven to rotate at high speed by a driving motor. During this process, ultrasonic signals are transmitted and received by the ultrasonic probe to perform casing damage detection and cementing quality evaluation.

Existing testing apparatuses share a common characteristic: they are equipped with an ultrasonic probe operating at specific frequencies that can evaluate casings within a certain thickness range. However, if the casing thickness exceeds the coverage range of the ultrasonic probe, another probe compatible with the casing thickness must be installed, and the well-logging operation must be repeated, leading to reduced operational efficiency in well-logging applications.

Furthermore, certain casings with severe corrosion have very thin casing walls, and corresponding resonance frequencies are significantly high. A single-frequency ultrasonic probe is unable to cover such a wide frequency range, leading to reduced accuracy in measuring the thicknesses of severely corroded casings.

Moreover, if the outer interface (the interface between the cement sheath and the formation) of the cement sheath need to be evaluated, it is necessary to ensure that the excitation frequency of the ultrasonic probe matches the resonance frequency of the casing so that ultrasonic waves can penetrate the casing and reach the cement sheath. However, due to the uncertainty of casing corrosion conditions and the fixed excitation frequency of ultrasonic probes in existing technologies, a single well-logging operation cannot effectively evaluate the outer interface of the cement sheath.

It is known from above that existing technologies suffer from low well-logging efficiency, poor measurement accuracy, and the inability to effectively evaluate the cementing quality at the outer interface of the cement sheath. Therefore, improving well-logging efficiency, enhancing measurement accuracy, and achieving evaluation of the cementing quality at the outer interface of the cement sheath are of significant importance for the exploration and development of oil and gas resources.

### SUMMARY

In order to solve some or all of the aforementioned problems, the present disclosure aims to provide a testing apparatus and method for casing damage while drilling and cementing quality evaluation that enables the cementing quality evaluation at the outer interface of the cement sheath, while also improving well-logging efficiency and enhancing measurement accuracy.

A first aspect, the present disclosure provides a testing apparatus for casing damage while drilling and cementing quality evaluation, comprising:
a drill collar sub, cylindrical in shape and configured to be coaxially connected to a bottom end of a drill collar;
a plurality of ultrasonic transducers embedded respectively within an outer surface of the drill collar sub;
an ultrasonic probe embedded within the outer surface of the drill collar sub, wherein an excitation frequency of the ultrasonic probe is adjustable via an external control module;
wherein the ultrasonic probe and the plurality of ultrasonic transducers are uniformly distributed along a circumferential direction of the drill collar sub, and wherein respective center frequencies of the plurality of ultrasonic transducers 3 are different from each other and progressively increase.

A second aspect, the present disclosure provides a testing method for casing damage while drilling and cementing quality evaluation, the method using the above described testing apparatus, and the method comprises the following steps:
S1, connecting the testing apparatus to a bottom end of a drill collar, and conveying the testing apparatus into a wellbore via the drill collar;
S2, transmitting and receiving respective ultrasonic waves by the plurality of ultrasonic transducers, thereby performing casing damage detection and cementing quality evaluation at the inner interface of the cement sheath;
S3, transmitting and receiving its own ultrasonic waves by each of the ultrasonic probe, thereby performing cementing quality evaluation at the outer interface of the cement sheath;
S4, transmitting and receiving its own ultrasonic waves by each of the mud sonic velocity probe, thereby performing measurement of the propagation velocity of ultrasonic waves through the mud;
S5, completing the testing and retrieving the testing apparatus.

As can be seen from the above technical solution, the testing apparatus and method for casing damage while drilling and cementing quality evaluation. provided in this disclosure offer the following advantages:
the apparatus employs a plurality of ultrasonic transducers with different center frequencies, thereby expanding the detection range of the testing apparatus; this apparatus enables the acquisition of both casing thickness and cement bonding quality curves across the full frequency spectrum in one well-logging operation; as a result, casing damage detection and cementing quality evaluation at the inner interface of the cement sheath can be completed during one well-logging operation, significantly improving well-logging efficiency. Meanwhile, by incorporating the ultrasonic probe with dynamically adjustable excitation frequency, the apparatus adjusts the excitation frequency of ultrasonic probe to match the resonance frequency of the casing, and this allows more ultrasonic energy to penetrate through the cement sheath, resulting in stronger reflected echoes from the outer interface of the cement sheath. As a result, the cement bonding quality at the outer interface of the cement sheath can be evaluated in one well-logging operation, thereby improving both well-logging efficiency and measurement accuracy. In addition, the arrangement includes a function for measuring the propagation velocity of ultrasonic waves in the mud. Based on the propagation velocity of ultrasonic waves in the mud, the inner diameter of the casing can be calculated. By comparing the measured inner diameter with the original inner diameter, it is possible to determine whether the corrosion occurs on the inner or outer surface of the casing. This method offers a convenient testing approach, significantly improving operational efficiency.

Other features and advantages of the present disclosure will become apparent from the following detailed description.

### BRIEF DESCRIPTION OF THE DRAWINGS

The drawings are provided to further understand the technical solution of the present disclosure and constitute part of the specification. Together with the embodiments, they are used to explain the technical solution of the present disclosure and do not limit the scope of the disclosure.

FIG. 1 is a structural schematic diagram illustrating the overall structure of Embodiment 1 of the present disclosure;

FIG. 2 is a sectional view of the testing apparatus in Embodiment 1 of the present disclosure;

FIG. 3 is a structural schematic diagram illustrating the testing apparatus enters the wellbore in Embodiment 1 of the present disclosure;

FIG. 4 is a sectional view of the drill collar sub in Embodiment 1 of the present disclosure;

FIG. 5 is a structural schematic diagram of the mud sonic velocity probe in Embodiment 1 of the present disclosure;

FIG. 6 is a sectional view of the mud sonic velocity probe in Embodiment 1 of the present disclosure;

FIG. 7 is a sectional view of the ultrasonic transducer in Embodiment 1 of the present disclosure;

FIG. 8 is a structural schematic diagram of the testing apparatus during testing in Embodiment 2 of the present disclosure;

FIG. 9 is a schematic diagram of the excitation spectrum curve of the ultrasonic transducer in Embodiment 2 of the present disclosure;

FIG. 10 is a schematic diagram of the excitation spectrum curve of the ultrasonic probe in Embodiment 2 of the present disclosure;

FIG. 11 is a waveform and spectrum curve diagram measured by ultrasonic transducer A₁ in Embodiment 2 of the present disclosure;

FIG. 12 is a waveform and spectrum curve diagram measured by ultrasonic transducer A₂ in Embodiment 2 of the present disclosure;

FIG. 13 is a waveform and spectrum curve diagram measured by ultrasonic transducer A₃ in Embodiment 2 of the present disclosure;

FIG. 14 is a flowchart illustrating the determination process for Mode 1 in Embodiment 2 of the present disclosure;

FIG. 15 is a flowchart illustrating the determination process for Mode 2 in Embodiment 2 of the present disclosure;

FIG. 16 is a flowchart illustrating the determination process for Mode 3 in Embodiment 2 of the present disclosure;

FIG. 17 is a excitation waveform and spectrum curve diagram from ultrasonic probe B in Embodiment 2 of the present disclosure;

FIG. 18 is a waveform diagram of the ultrasonic pulse reflected echo from ultrasonic probe B in Embodiment 2 of the present disclosure; and

FIG. 19 is a waveform diagram of the ultrasonic pulse reflected echo from the mud sonic velocity probe in Embodiment 2 of the present disclosure.

### REFERENCE NUMERALS

1—Drill collar sub; 2—Ultrasonic probe; 3—Ultrasonic transducer; 4—Plug; 5—Mud sonic velocity probe; 100—Testing apparatus; 200—Flow port; 400—Cement sheath; 500—Inner interface of cement sheath; 600—Outer interface of cement sheath; 700—Formation.

### DETAILED DESCRIPTION

To make the object, technical solutions and advantages of the present disclosure clearer and more readily understood, embodiments of the present disclosure will be described in detail below with reference to the accompanying drawings. It should be noted that, unless otherwise specified, the embodiments and features described in the embodiments of the present disclosure can be freely combined with one another where there is no conflict.

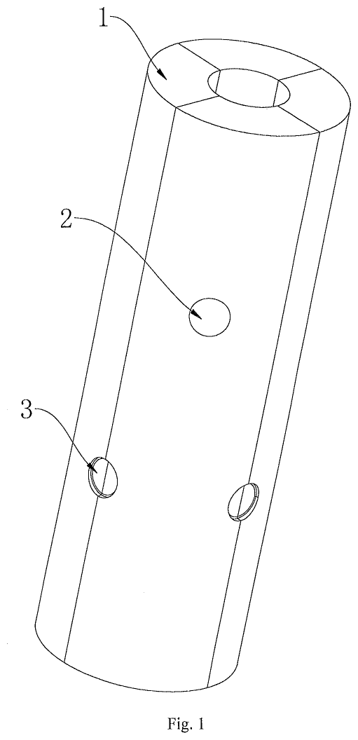

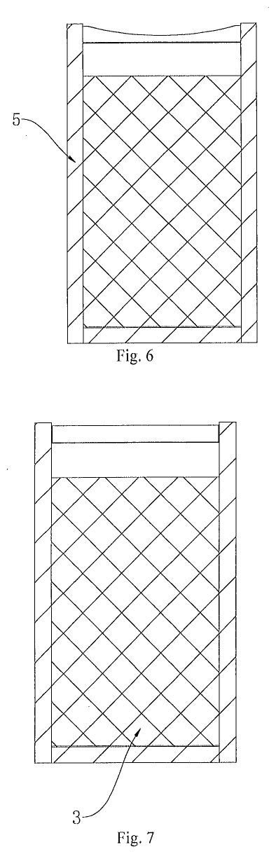

As shown in FIGS. 1 to 7, embodiment 1 of the present disclosure is illustrated. In this embodiment, a testing apparatus for casing damage while drilling and cementing quality evaluation is described. The testing apparatus comprises a generally cylindrical drill collar sub 1, which is configured to be coaxially connected to a bottom end of a drill collar. Alternatively, the drill collar sub 1 can be formed as part of the drill collar, that is, the drill collar sub 1 is integrally formed with the drill collar, which ensures that the testing apparatus rotates and moves together with the drill collar within the wellbore, thereby enabling logging while drilling (LWD) operations.

In one embodiment, as shown in FIGS. 1, 2, and 3, the outer surface of the drill collar sub 1 is embedded with an ultrasonic probe 2 and a plurality of ultrasonic transducers 3. The ultrasonic probe 2 and the plurality of ultrasonic transducers 3 are arranged in the same plane and are uniformly distributed along the circumferential direction of the drill collar sub 1. The excitation frequency of the ultrasonic probe 2 can be adjusted via an external control module. Furthermore, the respective center frequencies of the plurality of ultrasonic transducers 3 are different, and the center frequencies progressively increase.

In the embodiment, only three ultrasonic transducers 3 are illustrated. Specifically, the ultrasonic probe 2 and the three ultrasonic transducers 3 are spaced apart at intervals of 90° around the circumference of the drill collar sub 1. Of course, if the number of ultrasonic transducers 3 is five, the ultrasonic probe 2 and the five ultrasonic transducers 3 are spaced apart at intervals of 60° around the circumference of the drill collar sub 1. Other examples are not described in detail here.

In this embodiment, the testing apparatus for casing damage while drilling and cementing quality evaluation employs a plurality of ultrasonic transducers 3 with different center frequencies, thereby expanding the detection range of the testing apparatus. This configuration enables the acquisition of both casing thickness and cement bonding quality curves across the full frequency spectrum in one well-logging operation, and thus, casing damage detection and cementing quality evaluation at the inner interface 500 of the cement sheath can be completed during one well-logging operation, significantly improving well-logging efficiency. Meanwhile, by arranging the ultrasonic probe 2 with dynamically adjustable excitation frequency, the apparatus adjusts the excitation frequency of ultrasonic probe 2 to match the resonance frequency of the casing, and this allows ultrasonic energy can penetrate through the cement sheath 400 as completely as possible, resulting in stronger reflected echoes from the outer interface 600 of the cement sheath. As a result, the cement bonding quality at the outer interface 600 of the cement sheath can be evaluated in one well-logging operation, thereby improving both well-logging efficiency and measurement accuracy.

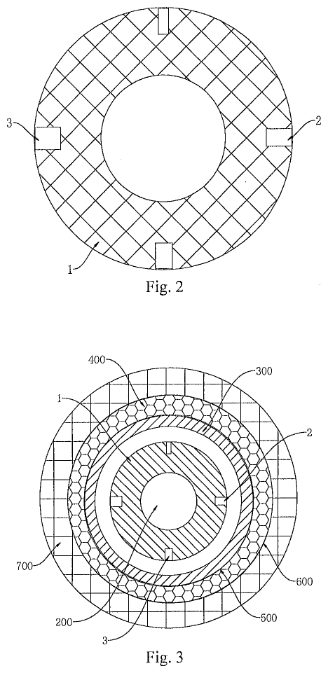

In one embodiment, as shown in FIGS. 2 and 3, the center frequencies of the ultrasonic transducers 3 range from 50 kHz to 650 kHz, and the excitation frequency of the ultrasonic probe 2 range from 200 kHz to 500 kHz. In this embodiment, the three ultrasonic transducers 3 have center frequencies of 200 kHz, 350 kHz, and 500 kHz, respectively, with a relative bandwidth of approximately 80% at −6 dB. The ultrasonic probe 2 has an initial excitation frequency of 350 KHz and a relative bandwidth of approximately 120% at −6 dB. It can be seen that the bandwidth of the ultrasonic probe 2 is wider than that of the ultrasonic transducers 3. This wider bandwidth of the ultrasonic probe 2 facilitates the complete penetration of ultrasonic energy through the cement sheath 400, thereby enhancing the accuracy of cementing quality evaluation at the outer interface 600 of the cement sheath.

In other embodiments, the center frequencies of the ultrasonic transducers 3 and the excitation frequency of the ultrasonic probe 2 can be set to other ranges or specific values, depending on the thickness of the casing 300 or actual operational requirements, which will not be described in detail herein.

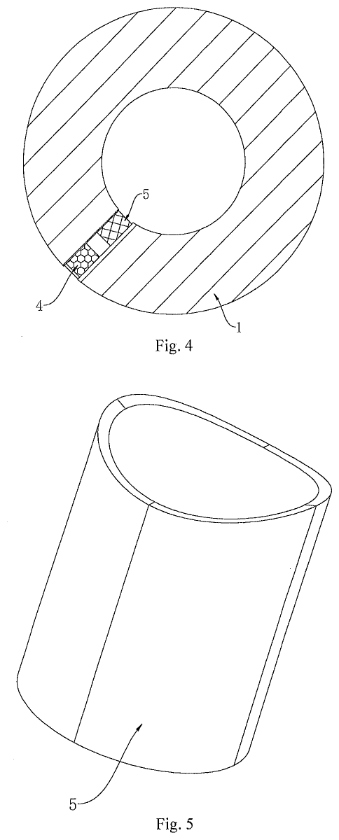

In one embodiment, as shown in FIGS. 1 and 4, a mud sonic velocity probe 5 is embedded on the inner surface of the drill collar sub 1. The mud sonic velocity probe 5 is configured to measure the sonic velocity of ultrasonic waves propagating through the drilling mud. By determination of the sonic velocity of the ultrasonic wave, the distance between the ultrasonic transducer 3 and the inner wall of the casing 300 can be calculated, and based on this distance, the inner diameter of the casing 300 can be derived. If casing damage detection indicates corrosion in the casing 300, comparing the measured inner diameter of the casing with the original inner diameter of the casing enables determination of whether the corrosion has occurred on the inner wall or outer wall of the casing 300. The specific testing method is described in detail in Embodiment 2.

In one embodiment, as shown in FIGS. 1 and 4, the mud sonic velocity probe 5 is not located in the same plane as the ultrasonic transducers 3. Instead, the mud sonic velocity probe 5 is positioned between two adjacent ultrasonic transducers 3, or between the ultrasonic probe 2 and an adjacent ultrasonic transducer 3.

In one embodiment, as shown in FIGS. 5, 6, and 7, a transmitting end of the mud velocity probe 5 has an arc surface and is flush with the inner surface of the drill collar sub 1, to reduce the risk of erosion on the transmitting end of the mud velocity probe 5 when drilling mud flows through the flow port 200 inside the drill collar sub 1. The transmitting ends of the ultrasonic transducers 3 and the transmitting end of the ultrasonic probe 2 both are flat, which facilitates efficient penetration of ultrasonic energy through the casing 300 and cement sheath 400.

In another embodiment, as shown in FIGS. 1 and 4, the mud sonic velocity probe 5 can be installed by machining a hole into the drill collar sub 1, embedding the mud sonic velocity probe 5 into one end of the hole, and sealing the other end with a plug 4 to prevent the mud from entering the hole. In other embodiments, a groove can be machined directly into the inner wall of the drill collar sub 1, and the mud sonic velocity probe 5 is then embedded within the groove. The excitation frequency of the mud sonic velocity probe 5 is determined based on the inner diameter (i.e., the inner diameter of the flow port 200) of the drill collar sub 1. For larger inner diameters of the drill collar sub 1, a lower frequency mud sonic velocity probe 5 is selected, whereas for smaller diameters of the drill collar sub 1, a higher frequency mud sonic velocity probe 5 is used, to improve the accuracy of ultrasonic sonic velocity measurements.

From the above, it can be seen that the testing apparatus according to this embodiment enables the acquisition of both casing thickness and cement bonding quality curves across the full frequency spectrum in a single logging run, and casing damage detection and cementing quality evaluation at the inner and outer interface of the cement sheath can be completed during one logging operation, significantly improving logging efficiency and measurement accuracy. Moreover, the apparatus includes a function for measuring the sonic velocity of ultrasonic waves in the mud. Based on the sonic velocity of ultrasonic waves in the mud, the inner diameter of the casing 300 can be calculated. By comparing the measured inner diameter with the original inner diameter, it is possible to determine whether the corrosion occurs on the inner or outer surface of the casing 300. This method offers a convenient testing approach, significantly improving operational efficiency.

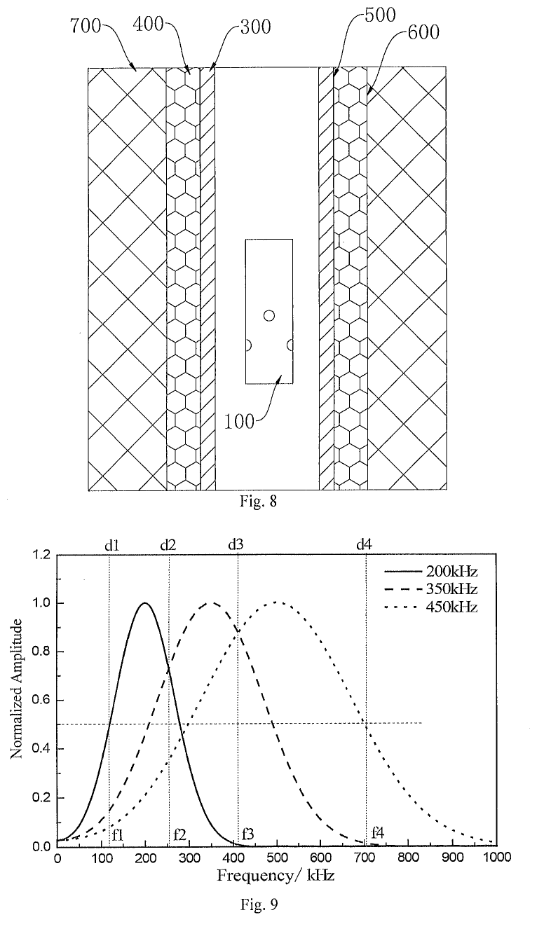

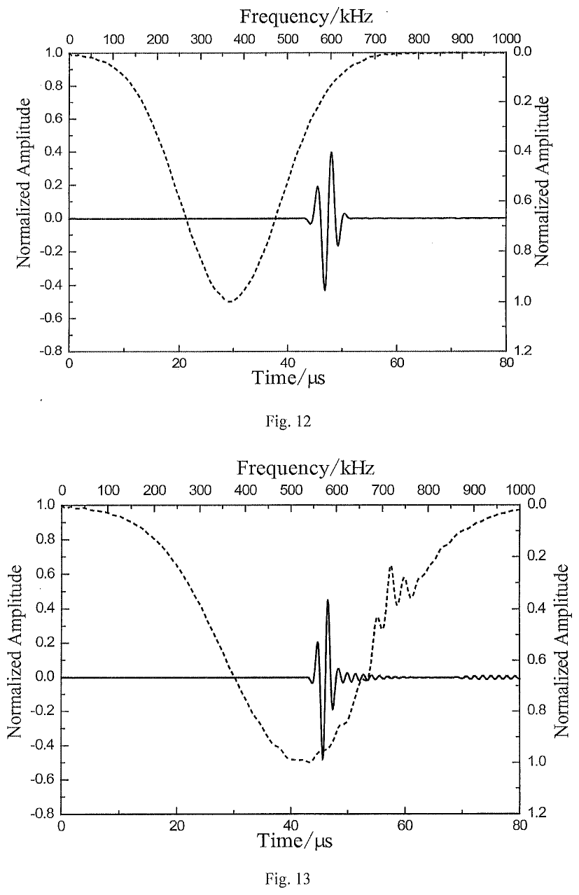

As shown in FIGS. 8 to 19, embodiment 2 of the present disclosure is illustrated. This embodiment discloses a method for casing damage while drilling and cementing quality evaluation using the testing apparatus 100 described in Embodiment 1. The method includes the following steps:
S1: connecting the testing apparatus 100 to a bottom end of a drill collar, and conveying the testing apparatus 100 into a wellbore via the drill collar, then driving the testing apparatus 100 to move synchronously by the rotational and reciprocating motion of the drill collar;
S2: transmitting and receiving respective ultrasonic waves by the plurality of ultrasonic transducers 3, thereby performing casing damage detection and cementing quality evaluation at the inner interface 500 of the cement sheath;
S3: transmitting and receiving its own ultrasonic waves by the ultrasonic probe 2, thereby performing cementing quality evaluation at the outer interface 600 of the cement sheath; S4: transmitting and receiving its own ultrasonic waves by the mud sonic velocity probe 5, thereby performing measurement of the propagation velocity of ultrasonic waves through the mud; S5: completing the testing and retrieving the testing apparatus 100.

In one embodiment, as shown in FIG. 9, in step S2, the plurality of ultrasonic transducers 3 are labeled sequentially as A₁, A₂, A₃, . . . , A_{N}, and the center frequencies of the ultrasonic transducers A₁, A₂, A₃, . . . to A_{N} progressively increase. The maximum detectable casing thickness dₘₐₓ for each ultrasonic transducer A₁, A₂, A₃, . . . to A_{N} is calculated. Based on maximum detectable casing thickness dₘₐₓ for each ultrasonic transducer A₁, A₂, A₃, . . . to A_{N}, it can be determined whether the ultrasonic transducer 3 is capable of performing casing damage detection and cementing quality evaluation at the inner interface 500 of the cement sheath. The specific calculation method is as follows:
firstly, in a water pool of a laboratory, obtaining the reflected echo spectrum curves of ultrasonic transducers A₁, A₂, A₃, . . . to A_{N} individually, calculating the lower frequency limit f₁ corresponding to a 50% reduction in the spectral amplitude for ultrasonic transducer A₁, and obtaining the maximum detectable casing thickness d₁ for ultrasonic transducer A₁ by using the half-wave transmission formula d=c/(2f), where d represents the casing thickness, c represents the longitudinal wave velocity constant of the ultrasonic wave in the casing;
next, obtaining the frequency f₂ corresponding to the intersection point of the reflected echo spectrum curves of ultrasonic transducers A₁ and A₂, and obtaining the maximum detectable casing thickness d₂ for ultrasonic transducer A₂ by using the half-wave transmission formula d=c/(2f);
subsequently, obtaining the frequency f₃ corresponding to the intersection point of the reflected echo spectrum curves of ultrasonic transducers A₂ and A₃, and obtaining the maximum detectable casing thickness d₃ for ultrasonic transducer A₃ by using the half-wave transmission formula d=c/(2f);
by analogy, obtaining the frequency f_{N} corresponding to the intersection point of the reflected echo spectrum curves of ultrasonic transducers A_{N-1} and A_{N}, and obtaining the maximum detectable casing thickness de for ultrasonic transducer A_{N} by using the half-wave transmission formula d=c/(2f). On basis of the maximum detectable casing thicknesses of the ultrasonic transducers 3, it can be determined whether each ultrasonic transducer 3 is suitable for performing casing damage detection and cementing quality evaluation at the inner interface 500 of the cement sheath.

In step S2, based on the original thickness X of the casing 300 and the maximum detectable casing thicknesses d₁, d₂, d₃, . . . to d_{N} of the ultrasonic transducers A₁, A₂, A₃, . . . to A_{N}, a suitable measurement mode is selected. The specific measurement modes are as follows:
Mode 1: If d₂<X≤d₁, all ultrasonic transducers A₁, A₂, A₃, . . . to A_{N} need to operate simultaneously;
Mode 2: If d₃<X≤d₂, ultrasonic transducers A₂, A₃, . . . to A_{N} need to operate simultaneously;
Mode 3: If d₄<X≤d₃, ultrasonic transducers A₃, . . . to A_{N} need to operate simultaneously;
. . . ,
Mode N: If d_{N+1}<X≤d_{N}, only ultrasonic transducer A_{N} need to operate.

By selection of an appropriate measurement mode to measure casing 300 according to the original thickness of the casing 300, more accurate test data can be obtained. This approach avoids unnecessary data filtering subsequently, thereby improving both logging efficiency and measurement accuracy.

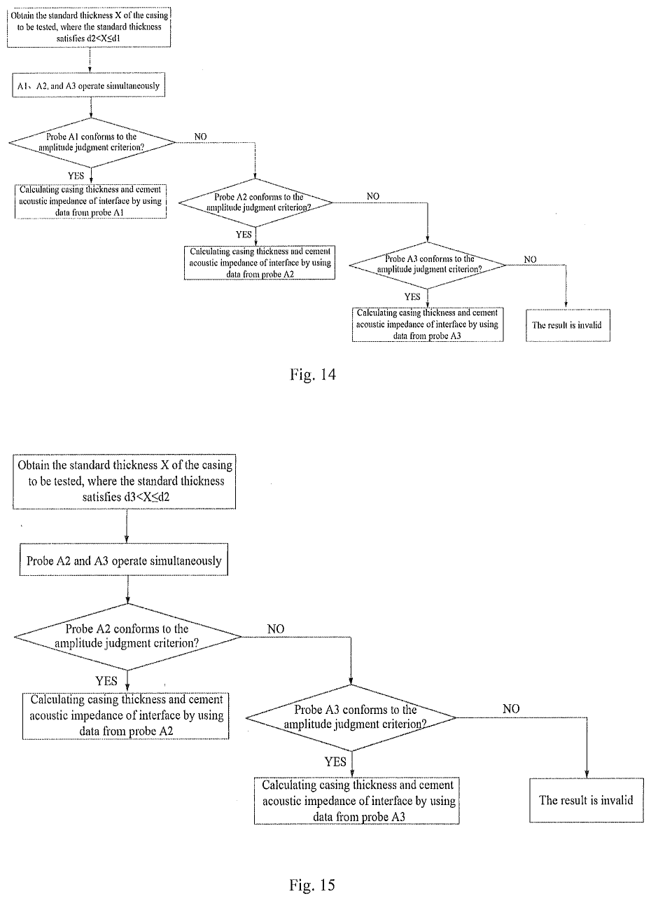

In one embodiment, as shown in FIGS. 14, 15, and 16, in step S2, based on the selected measurement mode and in accordance with the amplitude judgment criterion, the corresponding ultrasonic transducer 3 is selected for testing. The specific amplitude judgment criterion is as follows:

the amplitude judgment criterion is defined as:

$$\frac{Amp\_resonance}{Amp\_reflection} < δ ,$$

where Amp_resonance represents the amplitude of the casing resonance wave, Amp_reflection represents the amplitude of the reflected wave from the inner wall of the casing, δ represents a threshold parameter and typically set to be 0.01, and the calculation results for ultrasonic transducers A₁, A₂, A₃, . . . to A_{N} are denoted as δ₁, δ₂, δ₃, . . . to δ_{N}, respectively;
if δ₁<δ, it indicates that ultrasonic transducer A₁ does not meet the measurement requirements for casing thickness, and then ultrasonic transducer A₂ is evaluated;
if δ₂<δ, it indicates that ultrasonic transducer A₂ also fails to meet the measurement requirements for casing thickness, and then ultrasonic transducer A₃ is evaluated;
by analogy, until the threshold parameter of a certain ultrasonic transducer 3 satisfies δₙ≥δ, the transducer 3 is selected for testing, and casing damage detection and cementing quality evaluation at the inner interface 500 of the cement sheath are performed based on the test results from the selected transducer. If none of the ultrasonic transducers 3 meet the measurement requirements, it is determined that testing cannot be performed.

When the ultrasonic transducer 3 is operating, it first emits an ultrasonic pulse signal. The ultrasonic pulse signal propagates through the drilling fluid and is incident on the inner wall of the casing 300. At this stage, the majority of the sonic energy is reflected back and received by the ultrasonic transducer 3. The first arriving wave corresponds to the reflected waveform from the inner wall of the casing 300. The amplitude of this reflected wave can be used to detect corrosion on the inner surface of the casing 300.

The residual sonic energy after reflection from the inner wall of the casing 300 enters the casing 300. The sonic pulse signal undergoes multiple reflections at the interfaces between the casing 300 and the cement sheath 400 (inner interface 500 of the cement sheath), as well as between the cement sheath 400 and the surface of the formation 700 (outer interface 600 of the cement sheath). At each interface, part of the energy is reflected while the remainder continues to propagate. The amount of energy reflected depends on the difference in sonic impedance between the two materials.

Since the sonic impedance of the casing 300 and the sonic impedance of the drilling fluid are constants, the signal within the casing 300 decays at a predictable rate. The magnitude of the signal depends on the sonic impedance of the external material of the casing 300. A higher sonic impedance of the external material of the casing 300 results in a smaller amplitude of resonance wave in the casing 300. Conversely, a lower sonic impedance of the external material of the casing 300 leads to a larger amplitude of resonance wave in the casing 300.

Therefore, the strength of the amplitude of resonance wave in the casing 300 can be used to evaluate the sonic impedance of the external material of the casing 300, which in turn enables evaluation of the cement bonding quality (i.e. the inner interface 500 of the cement sheath) out of the casing 300. In addition, the resonance wave in the casing and the longitudinal wave propagation velocity of the ultrasonic wave in the casing 300 can be used to evaluate the thickness of the casing 300.

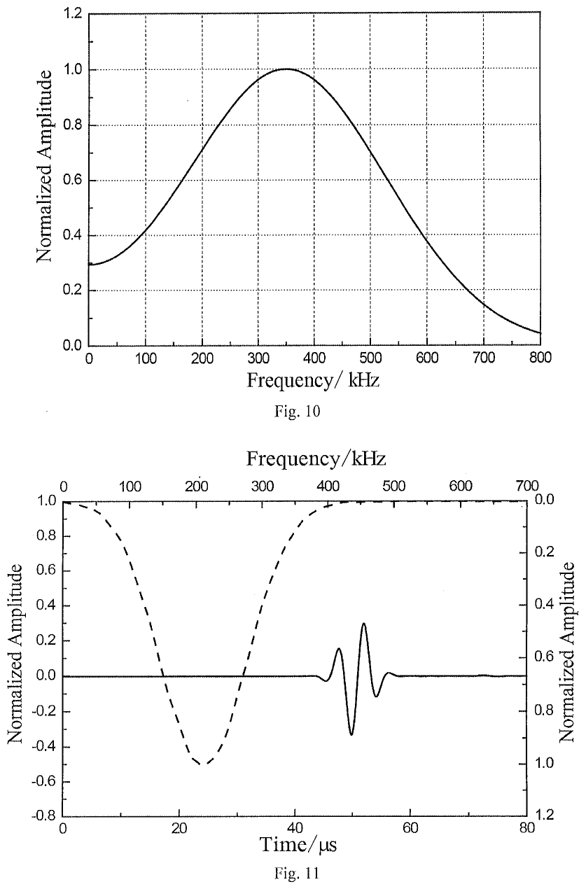

In one embodiment, as shown in FIG. 10, in step S3, the ultrasonic probe 2 is labeled as B. The minimum detectable casing thickness dₘᵢₙ of the ultrasonic probe B is calculated to determine whether the probe 2 is capable of performing cementing quality evaluation at the outer interface 600 of the cement sheath. The specific calculation method is as follows:
firstly, the reflected echo spectrum curve of ultrasonic probe B is obtained in a water tank under laboratory conditions; then, a upper frequency limit f_{B} corresponding to a 50% reduction in the spectral amplitude of the ultrasonic probe B is measured in the laboratory; by using the half-wave transmission formula: d=c/(2f), where d represents the thickness of the casing 300, c represents the longitudinal wave velocity constant of ultrasonic waves in the casing 300, the minimum detectable casing thickness d_{B} of the ultrasonic probe B can be calculated; based on this minimum detectable casing thickness d_{B}, it can be determined whether ultrasonic probe 2 is suitable for performing cementing quality evaluation at the outer interface 600 of the cement sheath.

The evaluation mode for cementing quality evaluation at the outer interface 600 comprises two types: one is the average value measurement method, and the other is the dynamic value measurement method, as described below.

### (1) Average Value Measurement Method

The external control module gradually adjusts the excitation frequency of ultrasonic probe B to match the average resonance frequency of the casing 300 along its circumferential direction. Specifically, as the drill collar rotates at a given depth point, the excitation frequency of the ultrasonic probe B is adjusted based on the average resonance frequency of the casing 300 around the full circumference at that depth point. The detailed procedure is as follows:
at the initial depth point, the average casing thickness D_depth¹ of the initial depth point is obtained based on all casing thickness measurements measured by the ultrasonic transducers 3 at the initial depth point; the casing resonance frequency F_depth¹ corresponding to the average casing thickness is calculated by the half-wave transmission formula d=c/(2f); at this stage, the initial excitation frequency of the ultrasonic probe B is set to be F_depth⁰, and the ultrasonic probe B performs measurement at the initial excitation frequency F_depth⁰ at the initial depth point;
at the next depth point, the average casing thickness D_depth² of the current depth point is obtained based on all the casing thickness measured by the ultrasonic transducers 3 at this depth point; again, by the half-wave transmission formula d=c/(2f), the casing resonance frequency F_depth² corresponding to the average casing thickness is calculated; the external control module then adjusts the excitation frequency of the ultrasonic probe B to be F_depth¹, and the ultrasonic probe B performs measurement at the excitation frequency F_depth¹ at this depth point;
at the subsequent depth point, the average casing thickness D_depth³ of the current depth point is obtained based on all the casing thickness measured by the ultrasonic transducers 3 at this depth point; again, by the half-wave transmission formula d=c/(2f), the casing resonance frequency F_depth³ corresponding to the average casing thickness is calculated; the external control module then adjusts the excitation frequency of the ultrasonic probe B to be F_depth², and the ultrasonic probe B performs measurement at the excitation frequency F_depth² at this depth point;
by analogy, the casing resonance frequency at the previous depth point is used as the excitation frequency for the ultrasonic probe B at the current depth point to perform testing; this method enables the cementing quality evaluation at the outer interface 600 of the cement sheath. Due to the relatively short advancement distance of the drill collar each time, the variation in the inner wall thickness of casing 300 is relatively small. Therefore, the casing thickness at the next depth point can be approximately considered equal to that at the current depth point, resulting in only minor changes in the casing resonance frequency. Consequently, using the casing resonance frequency from the previous depth point as the excitation frequency for ultrasonic probe B at the current depth point ensures sufficient ultrasonic wave transmission through casing 300; this enables effective the cement quality evaluation at the outer interface 600 of the cement sheath.

### (2) Dynamic Value Measurement Method

The external control module dynamically adjusts the excitation frequency of the ultrasonic probe B in real time, so that the excitation frequency of the ultrasonic probe B matches the resonance frequency of the casing 300 at each circumferential position. Specifically, as the drill collar rotates at a given depth point, the excitation frequency of the ultrasonic probe B is dynamically adjusted in real time based on the resonance frequencies measured at different points around the circumference of the casing 300. The detailed procedure is as follows:
at the current depth point, the casing thicknesses D_depthᵢ of each angular position at the current depth point are obtained based on the casing thickness obtained by the ultrasonic transducers 3 at this depth point; by the half-wave transmission formula d=c/(2f), the casing resonance frequency F_depthᵢ corresponding to each position along casing 300 is calculated; at this stage, the external control module dynamically adjusts the excitation frequency F_depth of the ultrasonic probe B in real time, ensuring that the excitation frequency F_depth of the ultrasonic probe B matches the resonance frequency of the casing at each position;
at the next depth point, the casing thicknesses D_depthᵢ of each angular position at the current depth point are obtained based on the casing thickness obtained by the ultrasonic transducers 3 at this depth point; by the half-wave transmission formula d=c/(2f), the casing resonance frequency F_depthᵢ corresponding to each position along casing 300 is calculated; at this stage, the external control module dynamically adjusts the excitation frequency F_depth of the ultrasonic probe B in real time, ensuring that the excitation frequency F_depth of the ultrasonic probe B matches the resonance frequency of the casing at each angular position;
by analogy, based on the casing thickness D_depth at each position of the current depth point, the external control module dynamically adjusts the excitation frequency F_depth of the ultrasonic probe B in real time; the ultrasonic probe B operating with real-time adjustment of its excitation frequency, is used to perform measurements, enabling the cementing quality evaluation at the outer interface 600 of the cement sheath. By dynamically adjusting the excitation frequency of ultrasonic probe B, this method ensures that the ultrasonic wave can effectively penetrate the casing 300, thereby significantly improving the accuracy of cementing quality evaluation at the outer interface 600 of the cement sheath.

As illustrated in FIGS. 9 to 18, the following provides a detailed example of this embodiment for the purpose of clearly explaining the embodiment.

As illustrated in FIGS. 9 and 10, three ultrasonic transducers 3 are used in this example, labeled as A₁, A₂ and A₃. The corresponding frequencies of ultrasonic transducers A₁, A₂ and A₃ are 200 kHz, 350 kHz and 500 kHz, respectively. The initial excitation frequency of the ultrasonic probe B is set to be 350 kHz.

The lower frequency limit f₁ corresponding to a 50% reduction in the spectral amplitude for ultrasonic transducer A₁ is equal to 119 kHz. According to half-wave transmission principle of ultrasonic waves in the casing and by using the half-wave transmission formula d=c/(2f), the maximum detectable casing thickness for ultrasonic transducer A₁ is calculated as d₁=23.9 mm.

The frequency f₂ corresponding to the intersection point of the reflected echo spectrum curves of ultrasonic transducers A₁ and A₂ is obtained as 254.5 kHz. By the same formula, the maximum detectable casing thickness for ultrasonic transducer A₂ is calculated as d₂=11.2 mm.

Similarly, the frequency f₃ corresponding to the intersection point of the reflected echo spectrum curves of ultrasonic transducers A₂ and A₃ is obtained as 411 kHz. By the same formula, the maximum detectable casing thickness for ultrasonic transducer A₃ is determined as d₃=6.9 mm.

The upper frequency limit f_{B} corresponding to a 50% reduction in the spectral amplitude of ultrasonic probe B is measured as 705 kHz. By the same formula, the minimum detectable casing thickness for the ultrasonic probe B is calculated as d_{B}=4.0 mm. Since this embodiment employs a combination measurement mode with three ultrasonic transducers, it can cover the casing 300 of the casing thicknesses ranging from 4.0 mm to 23.9 mm in a single downhole operation.

As shown in FIGS. 11, 12, 13, and 14, if the original casing thickness of the casing 300 is X=13 mm and due to severe corrosion, the actual casing thickness of the casing 300 has become 4 mm, firstly d₂<X≤d₁ can be determined and then measurement mode 1 is selected, which means all three ultrasonic transducers A₁, A₂, A₃ operate simultaneously.

According to the amplitude judgment criterion

$$\frac{Amp\_resonance}{Amp\_reflection} < δ ,$$

for ultrasonic transducer A₁,

$$\frac{Amp\_resonance}{Amp\_reflection} = 0.002 = {δ}_{1} ,$$

which belongs to the situation δ₁<δ, and transducer A₁ cannot obtain an accurate measurement of the casing thickness. At this point, ultrasonic transducer A₂ is evaluated.

For ultrasonic transducer A₂,

$$\frac{Amp\_resonance}{Amp\_reflection} = 0.003 = {δ}_{2} ,$$

which belongs to the situation δ₂<δ, and transducer A₂ cannot obtain an accurate measurement of the casing thickness. At this point, ultrasonic transducer A₃ is evaluated.

For ultrasonic transducer A₃,

$$\frac{Amp\_resonance}{Amp\_reflection} = 0.12 = {δ}_{3}$$

which satisfies δ₃>δ, and transducer A₃ cannot obtain an accurate measurement of the casing thickness. Therefore, the test results obtained from ultrasonic transducer A₃ are used to perform casing damage detection and cementing quality evaluation at the inner interface 500 of the cement sheath.

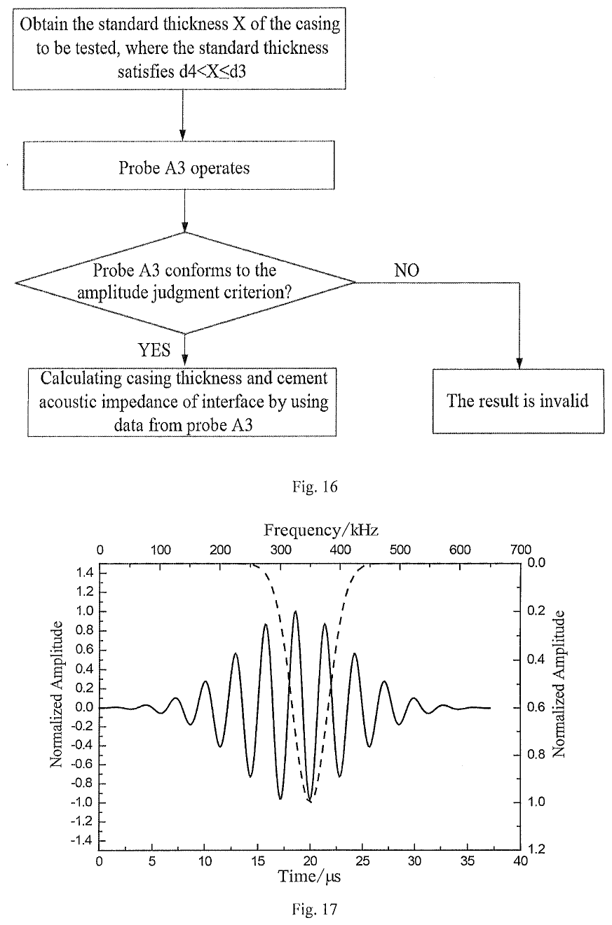

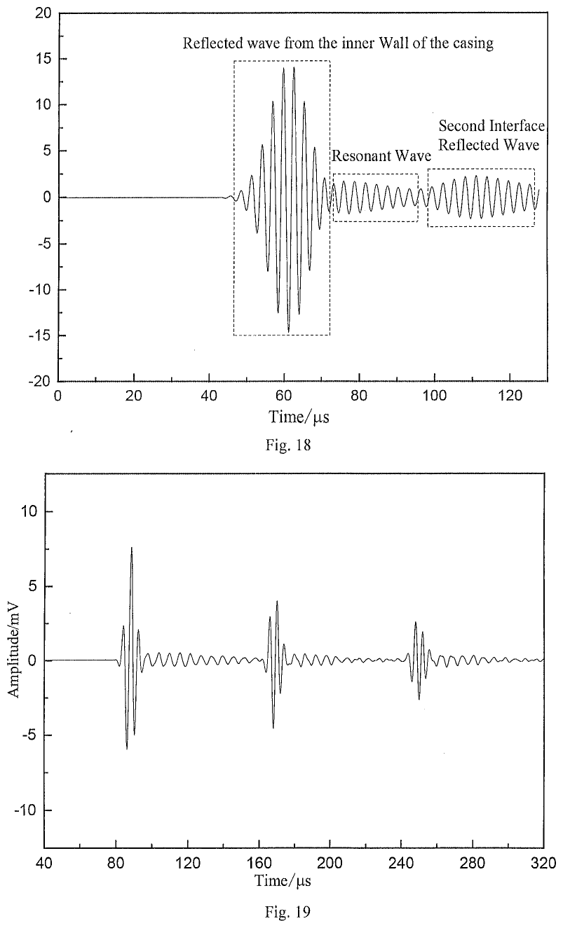

When the thickness of casing 300 is 8.1 mm, a Gaussian-modulated sinusoidal wave with a center frequency of 350 kHz and 11 cycles is applied to the ultrasonic probe B. It can be seen from FIG. 17 that the excitation signal has a very frequency band, which results in highly concentrated ultrasonic energy that can effectively penetrate through cement sheath 400. As illustrated in FIG. 18, the first wave to reach the maximum signal amplitude is the reflected wave from the inner wall of the casing, the second wave to reach the maximum signal amplitude is the casing resonance wave, and the last wave to reach the maximum signal amplitude is the reflected wave from the interface (i.e., the outer interface 600 of the cement sheath) between the cement sheath 400 and the formation 700. The bonding quality at outer interface 600 of the cement sheath can be evaluated based on the reflected wave from the outer interface 600 of the cement sheath.

In one embodiment, as shown in FIG. 19, in step S4, the sonic velocity V of the ultrasonic wave in the mud is calculated based on the echo arrival time T₁ of the mud sonic velocity probe 5 and the inner diameter L of the drill collar sub 1. Since the inner diameter L of the drill collar sub 1 is known, when the mud sonic velocity probe 5 emits an ultrasonic signal toward the flow port 200 on other side, the ultrasonic wave will reflect off the inner wall of the flow port 200 on other side, then be incident on the surface of the mud sonic velocity probe 5 and reflect again. As a result, the ultrasonic signal will undergo multiple reflections back and forth within the flow port 200. By any two peak arrival time of the reflected wave, the sonic velocity V of the ultrasonic wave in the mud can be calculated.

Similarly, the echo arrival time T₂ of ultrasonic transducer 3 is calculated. Based on the echo arrival time T₂ and the ultrasonic sonic velocity V, the distance S₁ between ultrasonic transducer 3 and the inner wall of casing 300 can be obtained. Subsequently, by summing the inner diameter L of drill collar sub 1, the distance S₁ between ultrasonic transducer 3 and the inner wall of casing 300, and the wall thickness of drill collar sub 1, the inner diameter S2 of casing 300 is derived.

When the casing damage detection test result indicates that casing 300 has been corroded, if the measured inner diameter S2 of the casing 300 is smaller than the original inner diameter X of the casing 300, it is determined that the inner surface of casing 300 has been corroded, and if the inner diameter S2 of the casing 300 is approximately equal to the original inner diameter X of the casing 300, it is determined that the outer surface of the casing 300 has experienced corrosion.

From the above, it can be seen that this testing method enables rapid and accurate measurement of casing thickness, thereby improving the accuracy of casing damage detection and the cement quality evaluation of the inner and outer interface of the cement sheath. Moreover, by calculating the inner diameter of the casing 300 via the mud velocity and comparing it with the original inner diameter, it is possible to determine whether the corrosion occurs on the inner or outer surface of the casing, which is convenient and significantly improves operational efficiency.

It should be noted that, unless otherwise specified, the technical terms or scientific terms used in this disclosure shall be understood in their commonly accepted meanings by those skilled in the art to which this disclosure belongs.

Furthermore, the terms “first” “second” and the like are used solely for descriptive purposes and should not be interpreted as indicating or implying relative importance, nor should they be taken as an indication of the number of technical features involved. In the context of this disclosure, the term “plurality” means two or more, unless otherwise clearly and specifically defined.

Finally, it should be emphasized that, the above embodiments are merely illustrative of the technical solutions of the present disclosure, and not intended to limit the same, and although the present disclosure has been described in detail with reference to the foregoing embodiments, it will be appreciated by those skilled in the art that modifications may still be made to the technical solutions described in the foregoing embodiments, or some or all of the technical features may be equivalently substituted. Such modifications or substitutions do not cause the essence of the technical solutions to depart from the scope of the technical solutions of the respective embodiments of the present utility model, and they should all be included within the scope of the claims and specification of this utility model. In particular, as long as there is no structural conflict, the various technical features mentioned in the individual embodiments can be combined in any manner. The present disclosure is not limited to the specific embodiments disclosed in the text, but includes all technical solutions falling within the scope of the appended claims.

1. A testing apparatus for casing damage while drilling and cementing quality evaluation, comprising:
a drill collar sub (1), being cylindrical in shape and configured to be coaxially connected to a bottom end of a drill collar;
a plurality of ultrasonic transducers (3), embedded respectively within an outer surface of the drill collar sub (1);
an ultrasonic probe (2) embedded within the outer surface of the drill collar sub (1), wherein an excitation frequency of the ultrasonic probe (2) is adjustable via an external control module;
wherein the ultrasonic probe (2) and the plurality of ultrasonic transducers (3) are uniformly distributed along a circumferential direction of the drill collar sub (1), respective center frequencies of the plurality of ultrasonic transducers 3 are different from each other and progressively increase.

2. The testing apparatus according to claim 1, wherein the center frequencies of the ultrasonic transducers (3) range from 50 kHz to 650 kHz, and the excitation frequency of the ultrasonic probe (2) range from 200 kHz to 500 KHz.

3. The testing apparatus according to claim 2, wherein a mud sonic velocity probe (5) is embedded within an inner surface of the drill collar sub (1), wherein the mud sonic velocity probe (5) is configured to measure a propagation velocity of ultrasonic waves through drilling mud.

4. The testing apparatus according to claim 3, wherein a transmitting end of the mud sonic velocity probe (5) is arc-shaped and flush with the inner surface of the drill collar sub (1), and wherein a transmitting end of the ultrasonic probe (2) and transmitting ends of the ultrasonic transducers (3) are planar.

5. A testing method for casing damage while drilling and cementing quality evaluation, the method using the testing apparatus according to claim 1, wherein the method comprises the following steps:
S1, connecting the testing apparatus (100) to a bottom end of a drill collar, and conveying the testing apparatus (100) into a wellbore via the drill collar;
S2, transmitting and receiving respective ultrasonic waves by a plurality of ultrasonic transducers (3), thereby performing casing damage detection and cementing quality evaluation at an inner interface (500) of a cement sheath;
S3, transmitting and receiving ultrasonic probe (2)'s own ultrasonic waves by the ultrasonic probe (2), thereby performing cementing quality evaluation at an outer interface (600) of the cement sheath;
S4, transmitting and receiving mud sonic velocity probe (5)'s own ultrasonic waves by the mud sonic velocity probe (5), thereby performing measurement of the propagation velocity of ultrasonic waves through mud;
S5, completing the testing and retrieving the testing apparatus (100).

6. The testing method according to claim 5, wherein the plurality of ultrasonic transducers (3) are sequentially labeled A₁, A₂, A₃, . . . to A_{N}, and respective center frequencies of the ultrasonic transducers A₁, A₂, A₃, . . . to A_{N} progressively increase, wherein the step S2 comprises calculating a maximum detectable casing thickness dₘₐₓ of the ultrasonic transducers A₁, A₂, A₃, . . . to A_{N} that comprises following steps,
obtaining reflected echo spectrum curves of the ultrasonic transducers A₁, A₂, A₃ to A_{N} in a water tank under laboratory conditions; measuring, under the laboratory conditions, lower frequency limits f₁, f₂, f₃, . . . to f_{N} corresponding to a 50% reduction in spectral amplitude of the ultrasonic transducers A₁, A₂, A₃, . . . to A_{N};
obtaining the maximum detectable casing thickness d₁, d₂, d₃, . . . to d_{N} of the ultrasonic transducers A₁, A₂, A₃, . . . to A_{N} based on a half-wave transmission formula d=c/(2f), where d represents the thickness of the casing (300), c represents the longitudinal wave velocity constant of ultrasonic waves in the casing (300), to determine whether each ultrasonic transducer (3) is suitable for performing casing damage detection and cementing quality evaluation at the inner interface (500) of the cement sheath based on the maximum detectable casing thickness of the ultrasonic transducer (3).

7. The testing method according to claim 6, wherein a measurement mode is selected based on the maximum detectable casing thicknesses d₁, d₂, d₃, . . . to d_{N} of the ultrasonic transducers A₁, A₂, A₃, . . . to A_{N} and an original thickness X of the casing (300):
Mode 1: if d₂<X≤d₁, all ultrasonic transducers A₁, A₂, A₃, . . . to A_{N} operate simultaneously;
Mode 2: if d₃<X≤d₂, ultrasonic transducers A₂, A₃, . . . to A_{N} operate simultaneously;
Mode 3: if d₄<X≤d₃, ultrasonic transducers A₃, . . . to A_{N} operate simultaneously;
. . . ,
Mode N: if d_{N+1}<X≤d_{N}, only ultrasonic transducer A_{N} operates.

8. The testing method according to claim 7, wherein a corresponding ultrasonic transducer (3) is selected for testing based on a selected a measurement mode and an amplitude judgment criterion,
the amplitude judgment criterion being defined as
$$\frac{Amp\_resonance}{Amp\_reflection} < δ ,$$
where Amp_resonance is the amplitude of the casing resonance wave, Amp_reflection is the amplitude of the echo reflected from the inner wall of the casing, and δ is a threshold parameter; the threshold parameters for ultrasonic transducers A₁, A₂, A₃, . . . to A_{N} are calculated as denoted as δ₁, δ₂, δ₃, . . . to δ_{N}, respectively;
if δ₁<δ, it indicates that ultrasonic transducer A₁ does not meet the measurement requirements for casing thickness, and then ultrasonic transducer A₂ is evaluated;
if δ₂<δ, it indicates that ultrasonic transducer A₂ does not meet the measurement requirements for casing thickness, and then ultrasonic transducer A₃ is evaluated;
by analogy, until the threshold parameter of a certain ultrasonic transducer (3) satisfies δₙ≥θ, the certain ultrasonic transducer (3) is selected for testing, and casing damage detection and cementing quality evaluation at the inner interface (500) of the cement sheath are performed based on the test results from the selected ultrasonic transducer.

9. The testing method according to claim 6, wherein in step S3, the ultrasonic probe (2) is labeled as B, and a minimum detectable casing thickness dₘᵢₙ of the ultrasonic probe B is calculated according to following steps,
obtaining the reflected echo spectrum curve of the ultrasonic probe B in a water tank under laboratory conditions; measuring, under laboratory conditions, a upper frequency limit f_{B} corresponding to a 50% reduction in spectral amplitude of the ultrasonic probe B; calculating the minimum detectable casing thickness de of the ultrasonic probe B based on the half-wave transmission formula d=c/(2f), where d represents the thickness of the casing (300), c represents the longitudinal wave velocity constant of ultrasonic waves in the casing (300); and determining whether the ultrasonic probe (2) is suitable for performing cementing quality evaluation at the outer interface (600) of the cement sheath based on the minimum detectable casing thickness.

10. The testing method according to claim 9, wherein an external control module gradually adjusts the excitation frequency of the ultrasonic probe B to match an average resonance frequency of the casing along circumferential positions, which comprises following steps,
at an initial depth point, an average casing thickness D_depth¹ of the initial depth point is obtained based on the casing thickness obtained by the ultrasonic transducers (3) at the initial depth point; using the half-wave transmission formula d=c/(2f), where d represents the thickness of the casing (300), c represents the longitudinal wave velocity constant of ultrasonic waves in the casing (300), a casing resonance frequency F_depth¹ corresponding to the average thickness of the casing (300) is calculated; at this stage, an initial excitation frequency of the ultrasonic probe B is set to be F_depth⁰,
and the ultrasonic probe B performs measurement at the initial excitation frequency F_depth⁰ at the initial depth point;
at a next depth point, an average casing thickness D_depth² of the next depth point is obtained based on the casing thickness obtained by the ultrasonic transducers (3) at the next depth point; again, using the half-wave transmission formula d=c/(2f), where d represents the thickness of the casing (300), c represents the longitudinal wave velocity constant of ultrasonic waves in the casing (300), a casing resonance frequency F_depth² corresponding to the average thickness of the casing (300) is calculated; at this stage, the external control module adjusts the excitation frequency of the ultrasonic probe B to be F_depth¹, and the ultrasonic probe B performs measurement at the excitation frequency F_depth¹ at the next depth point;
at a subsequent depth point, an average casing thickness D_depth³ of the subsequent depth point is obtained based on the casing thickness obtained by the ultrasonic transducers (3) at the subsequent depth point; again, using the half-wave transmission formula d=c/(2f), where d represents the thickness of the casing (300), c represents the longitudinal wave velocity constant of ultrasonic waves in the casing (300), a casing resonance frequency F_depth³ corresponding to the average thickness of the casing (300) is calculated; at this stage, the external control module adjusts the excitation frequency of the ultrasonic probe B to be F_depth², and the ultrasonic probe B performs measurement at the excitation frequency F_depth² at the subsequent depth point;
by analogy, the casing resonance frequency obtained at a previous depth point is used as the excitation frequency for the ultrasonic probe B at a current depth point to perform testing, enabling the cementing quality evaluation at the outer interface (600) of the cement sheath.

11. The testing method according to claim 9, wherein the external control module dynamically adjusts the excitation frequency of the ultrasonic probe B in real time, so that the excitation frequency of the ultrasonic probe B matches the resonance frequency of the casing at each circumferential position, which comprises following steps,
at the current depth point, the casing thicknesses D_depthᵢ of each position at the current depth point are obtained based on the casing thickness obtained by the ultrasonic transducers (3) at the current depth point; using the half-wave transmission formula d=c/(2f), where d represents the thickness of the casing (300), c represents the longitudinal wave velocity constant of ultrasonic waves in the casing (300), a casing resonance frequency F_depthᵢ corresponding to each position along casing (300) is calculated; at this stage, the external control module dynamically adjusts the excitation frequency F_depth of the ultrasonic probe B in real time, ensuring that the excitation frequency F_depth of the ultrasonic probe B matches the resonance frequency of the casing at each position;
at a next depth point, a casing thicknesses D_depthᵢ of each position at the next depth point are obtained based on the casing thickness obtained by the ultrasonic transducers (3) at the next depth point; using the half-wave transmission formula d=c/(2f), where d represents the thickness of the casing (300), c represents the longitudinal wave velocity constant of ultrasonic waves in the casing (300), a casing resonance frequency F_depthᵢ corresponding to each position along casing (300) is calculated; at this stage, the external control module dynamically adjusts the excitation frequency F_depth of the ultrasonic probe B in real time, ensuring that the excitation frequency F_depth of the ultrasonic probe B matches the resonance frequency of the casing at each position;
by analogy, based on the casing thickness D_depth at each position of the current depth point; the external control module dynamically adjusts the excitation frequency F_depth of the ultrasonic probe B in real time; the ultrasonic probe B, operating with real-time adjustment of the excitation frequency, is used to perform measurements, enabling the cementing quality evaluation at the outer interface (600) of the cement sheath.

12. The testing method according to claim 5, wherein in step S4, the sonic velocity (V) of ultrasonic waves in the mud is calculated based on echo arrival time (T₁) of the mud sonic velocity probe (5) and an inner diameter (L) of the drill collar sub (1); a distance (S1) between the ultrasonic transducer (3) and the inner wall of the casing (300) is then determined based on echo arrival time (T₂) of the ultrasonic transducer (3) and the sonic velocity (V) of the ultrasonic waves; an inner diameter (S₂) of the casing is calculated according to the formula: S₂=L+S₁+t, wherein S₂ represents the inner diameter of the casing (300), S₁ represents the distance between the ultrasonic transducer (3) and the inner wall of the casing (300), and t represents the wall thickness of the drill collar sub (1);
when a test result of the casing damage detection indicates that the casing (300) has been corroded, if the measured inner diameter S₂ of the casing (300) is smaller than an original inner diameter X of the casing (300), it is determined that the inner surface of casing (300) has been corroded; and if the inner diameter S₂ of the casing (300) is approximately equal to the original inner diameter X of the casing (300), it is determined that the outer surface of casing (300) has experienced corrosion.
